(19) United States
(12) Patent Application Publication
(10) Pub. No.: US 2008/0122637 A1
(43) Pub. Date: May 29, 2008

(54) Method and Apparatus for Indicating Sanitary Water Temperature

(76) Inventor: Randall T. Meyer, Garland, TX (US)

Correspondence Address: WILLIAMS, MORGAN & AMERSON, 10333 RICHMOND, SUITE 1100, HOUSTON, TX, 77042, US

(21) Appl. No.: 11/557,001

(22) Filed: Nov. 6, 2006

(51) Int. Cl. G08B 23/00

(52) U.S. Cl. 340/584

(57) ABSTRACT

A method is provided for indicating that a water heater has ceased to produce water at a temperature useful for sanitizing procedures. A temperature sensor is deployed at or near the water heater, such as adjacent a water line extending from the water heater. The temperature sensor provides a signal having at least one parameter that relates to the temperature of the water exiting the water heater. In the event that the temperature falls below a level useful for sanitizing procedures, an alarm is activated. The alarm may be located locally or remote.

### BACKGROUND OF THE INVENTION

1. Field of the Invention

This invention relates generally to water heaters, and, more particularly, to a monitoring system for indicating when water temperature falls below a predetermined sanitary temperature.

2. Description of the Related Art

In the field of food preparation, such as at restaurants, cafeterias, grocery stores, or the like, cleaning and sanitizing procedures are precisely defined and strictly enforced to preserve the health and safety of the customers. For example, sanitation is precisely defined in an exemplary food sanitation code as, immersion for at least one-half minute in clean hot water at a temperature of not less than 170 degrees Fahrenheit (76.7 degrees Celsius). Those skilled in the field of food preparation will appreciate that sanitization is an effective bactericidal treatment by heat, which destroys pathogens on surfaces treated. Proper sanitation preserves the health of the public by dramatically reducing the presence of bacteria and pathogens on food preparation equipment, utensils and tableware.

Food sanitation codes commonly specify that the procedure must clean and sanitize the article so as to produce an average plate count of not more than 100 colonies on the surface of the utensils examined, with no coliform bacteria. It will be appreciated, however, that variations in the water temperature can significantly impact the effectiveness of the sanitizing procedure. Even relatively modest variations in water temperature can result in unacceptable contamination of the equipment, utensils and tableware. Generally, food sanitation codes require that the water temperature be manually monitored to insure that it is within acceptable limits. In particular, the food sanitation codes commonly require that a numerically scaled, indicating thermometer accurate to plus or minus two degrees Fahrenheit (1.1 degrees Celsius) be kept at a location convenient to the sink for frequent checks of water temperature. Such a system, of course, relies heavily on the discretion and memory of the dish washer, which may be subject to at least some abuse, particularly during relatively busy periods of time.

The present invention is directed to overcoming, or at least reducing, the effects of one or more of the problems set forth above.

### SUMMARY OF THE INVENTION

In one aspect of the instant invention, a method is provided for monitoring water temperature. The method comprises sensing water temperature, and activating an alarm in response to the water temperature falling below a preselected setpoint.

In another aspect of the instant invention, an apparatus is provided for monitoring water temperature. The apparatus comprises a water heater, a temperature sensor, a controller and an alarm. The temperature sensor is adapted to provide a signal having a parameter related to a temperature of water supplied by the water heater. The controller is adapted to compare the signal to a preselected setpoint and provide an alarm signal in response to the signal falling below the preselected setpoint. The alarm is adapted to be energized in response to receiving the alarm signal.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized diagram of a restaurant employing a temperature monitoring device in accordance with one embodiment of the present invention; and

FIG. 2 depicts a block diagram of one embodiment of an electrical control circuit that may be employed in the temperature monitoring device of FIG. 1;

FIGS. 3A and 3B depict stylized side and end views of one embodiment of a mounting arrangement for a temperature sensor that may be disposed adjacent a water heater and used in the temperature monitoring device of FIGS. 1 and 2;

FIG. 3C depicts an alternative embodiment of the instant invention in which the temperature sensor is positioned in direct contact with the heated water;

FIG. 4 depicts a flow chart of an alternative embodiment of a software based control circuit that may be employed in the temperature monitoring device of FIG. 1;

FIG. 5 is a stylized diagram of a restaurant employing a temperature monitoring device in accordance with another embodiment of the present invention; and

FIG. 6 depicts a flow chart of an alternative embodiment of a software based control circuit that may be employed in the temperature monitoring device of FIG. 5.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

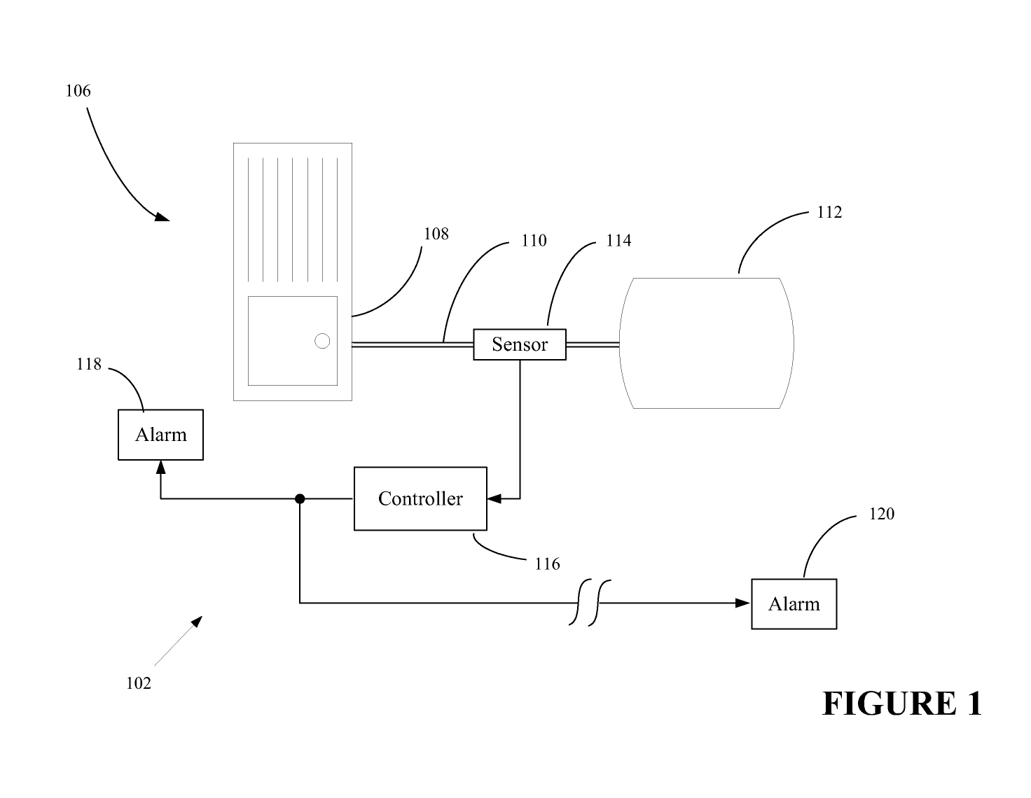

Turning now to the drawings and specifically referring to FIG. 1, a stylistic top view of at least a portion of a conventional restaurant with a temperature monitoring device 102 installed therein is illustrated, in accordance with one embodiment of the present invention. The restaurant includes a kitchen with a dishwashing area 106. The dishwashing area 106 may be comprised of a sink 108 and a faucet fixture (not shown). A water heater or boiler 112 is hydraulically coupled to the faucet fixture via a water line 110 so as to provide heated water into the sink 108 for immersing and washing the utensils and tableware used in the preparation and service of the restaurant fare.

The temperature monitoring device 102 includes a temperature sensor 114 thermally coupled to the water heater 112 or the water line 110 extending therefrom. The temperature sensor 114 is configured and calibrated to provide an electrical signal that has at least one characteristic related to the temperature of water supplied from the water heater 112. For example, the temperature sensor 114 may be configured to provide a voltage signal that varies in relation to the temperature of the water. Similarly, the temperature sensor 114 may also produce a current that varies with water temperature. Those skilled in the art will appreciate that variations in the voltage and/or current of the temperature sensor 114 may be affected by variations in the resistance of an electrically conductive material located within the temperature sensor 114. Those skilled in the art will appreciate that any of a variety of conventional temperature sensors 114 may be employed without departing from the spirit and scope of the instant invention.

The temperature sensor 114 is electrically coupled to a controller 116, which is, in turn, electrically coupled to an alarm 118. Generally, the controller 116 is responsible for comparing the measured water temperature with a predetermined setpoint, and activating the alarm 118 when the measured water temperature falls below the predetermined setpoint. The setpoint is normally selected to provide an indication when the water temperature has fallen below a level needed for adequate sanitization.

The alarm 118 may take any of a wide variety of forms, including an audible alarm, a visual alarm, or a combination thereof. The alarm 118 may be configured to visually flash and/or audibly beep in a manner to attract attention. In one embodiment of the instant invention, it may be useful to locate the alarm 118 in the dishwashing area 106 so as to immediately alert the dishwasher that the temperature of the water has fallen too low. Alternatively, the alarm 118 or a secondary alarm 120 may be located adjacent a manager's office, so that the manager may be alerted to promptly contact the manufacturer or a maintenance company to indicate that the water heater 112 is in need of service. The alarms 118, 120 may even be equipped to provide a contact telephone number of the maintenance company, visually or audibly.

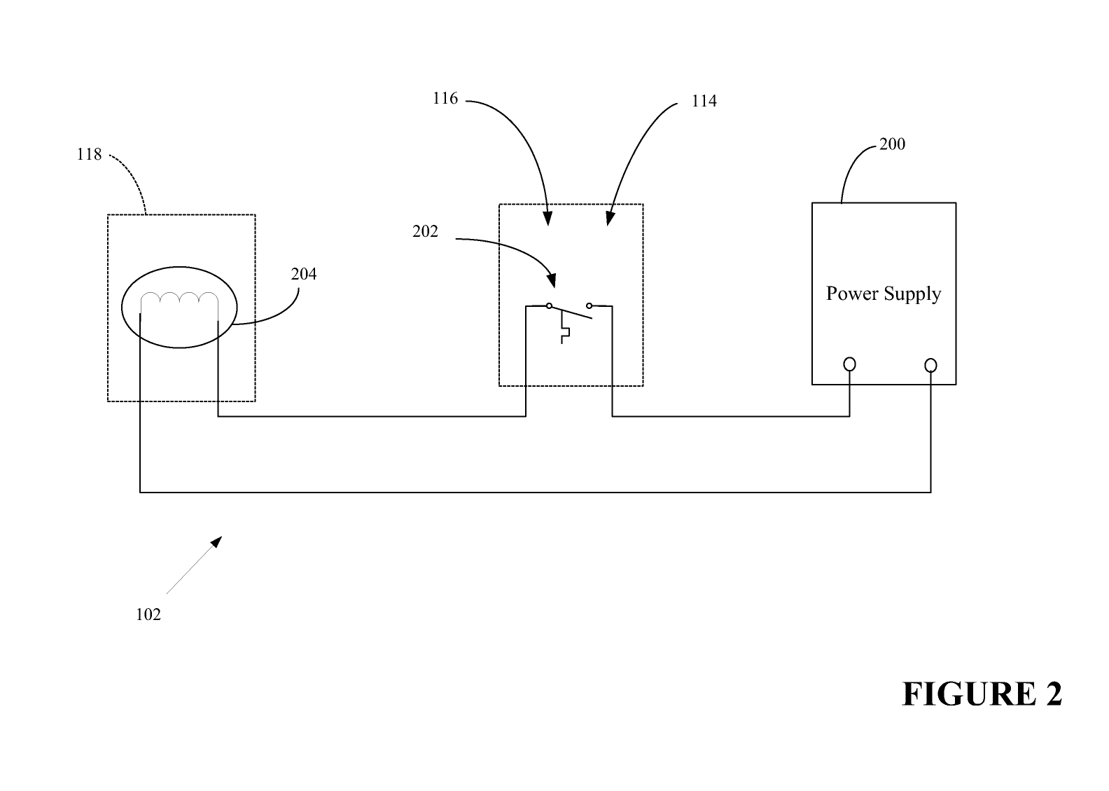

Turning now to FIG. 2, a circuit diagram of one embodiment of the temperature monitoring device 102 is shown. A power supply 200 is arranged to supply voltage and current to the temperature monitoring device 102. Those skilled in the art will appreciate that any of a variety of power supplies may be used without departing from the spirit and scope of the instant invention. In the illustrated embodiment the power supply 114 is a direct current (DC) power supply, which may be coupled to a conventional 110V alternating current (AC) source. One exemplary power supply that may be used in the instant invention is manufactured by Shortage Control Inc. as part no. BT-24-40.

The power supply 114 has a first terminal coupled to a first terminal of the temperature sensor 114. As discussed above, any of a variety of temperature sensors may be employed. In the illustrated embodiment, a temperature sensor manufacture by Portage Electric Products, Inc. as part no. C-106065-038H may be used. A switching mechanism 202 within the temperature sensor 114 is configured to operate at a desired temperature. Those skilled in the art will appreciate that the switching mechanism also functions as the controller 116. That is, when the actual temperature detected by the temperature sensor 114 falls below a predetermined setpoint, the switching mechanism 202 “closes,” passing current and voltage from the power supply 200 to a second terminal of the temperature sensor. The second terminal of the temperature sensor 114 is electrically coupled to a first terminal of the alarm 118, which in the illustrated embodiment is a light 204, such as a light emitting diode (LED), an incandescent bulb, a fluorescent lamp, or the like. A second terminal of the alarm 118 is coupled to a second terminal of the power supply 200.

Thus, it should be appreciated that when the water temperature sensed by the temperature sensor 114 falls below the predetermined setpoint, which has been selected based on sanitary requirements, the switching mechanism 202 closes. With the switching mechanism 202 closed, current and voltage pass to the alarm 118, causing the light 204 to energize. Those skilled in the art will appreciate that the alarm 118 may take the form of a flashing light, an audible alarm or a combination thereof, so as to generate sufficient activity that it will be noticed by restaurant personnel and acted upon.

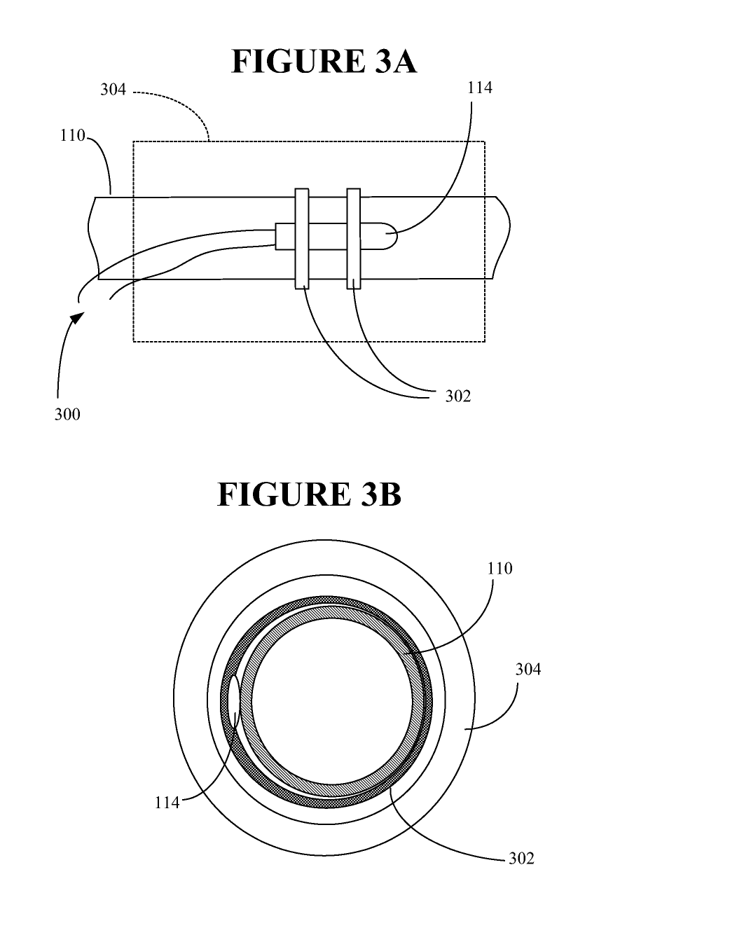

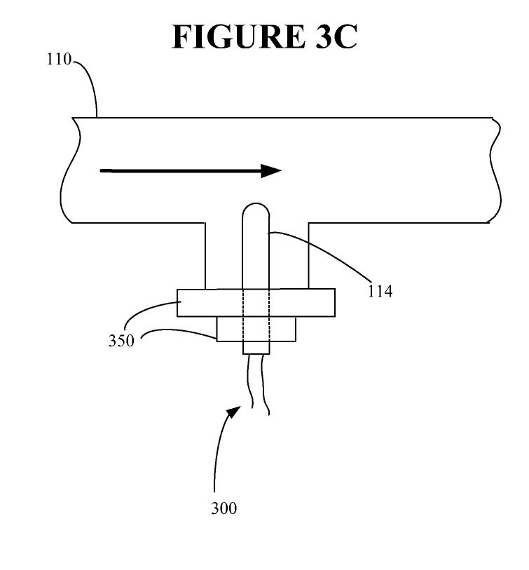

Referring now to FIGS. 3A and 3B, a stylized side and cross sectional end view of a mounting arrangement of the temperature sensor 114 on the water line 110 is shown. The temperature sensor 114 is mounted adjacent the water line 110 in close thermal contact therewith. Mounting of the temperature sensor 114 may be accomplished mechanically, chemically or by integral formation therewith. In the illustrated embodiment, the temperature sensor 114 is mechanically coupled to the water line 110 by one or more ties 302. The ties 302 provide sufficient for as to urge the temperature sensor 114 into close and secure contact with the water line 110 so that thermal energy is readily transferred from the water line 110 to the temperature sensor 114. In this way, the temperature experience by the temperature sensor 114 is closely related to the temperature of the water 110 located therein. Those skilled in the art will appreciate that electrically conductive lines 300 extend from the temperature sensor 114 and may be coupled to the alarm 118 and power supply 200, as shown in FIG. 2.

In some applications of the instant invention, it may be useful to provide a layer of insulation 304 around the water line 110 to reduce the likelihood that exterior air temperature will impact the temperature detected by the temperature sensor 114. Those skilled in the art will appreciate that the temperature sensor 114 may experience heat loss/gain to/from the surrounding environment, thereby reducing the accuracy with which the temperature sensor 114 is able to detect the temperature of the water. The insulation 304 may reduce such heat loss/gain. “The insulation 304 may take the form of conventional semi-rigid foam pipe insulation, and may be affixed to the water line 110 by any of a variety of techniques. For example, the insulation 304 may be affixed to the water line 304 by friction, tape, glue, mechanical fasteners, and the like. In one embodiment of the instant invention, the insulation 304 is affixed to the pipe by ties (not shown).

Referring now to FIG. 3C, a stylized side view of a mounting arrangement of the temperature sensor 114 within the water line 110 is shown. The temperature sensor 114 is mounted within a T-shaped section of the water line 110 in direct thermal contact with the heated water. Mounting of the temperature sensor 114 may be accomplished mechanically, chemically or by integral formation therewith. In the illustrated embodiment, the temperature sensor 114 is mechanically coupled to the water line 110 by one or more conventional nuts 350 that threadably engage the T-shaped section of the water line 110. Those skilled in the art will appreciate that various sealing mechanisms, such as washers, O-rings, and the like (not shown), may be employed to prevent leakage of hot water from the water line 110 through the nuts 350 and temperature sensor 114. Further, those skilled in the art will appreciate that electrically conductive lines 300 extend from the temperature sensor 114 and may be coupled to the alarm 118 and power supply 200, as shown in FIG. 2.

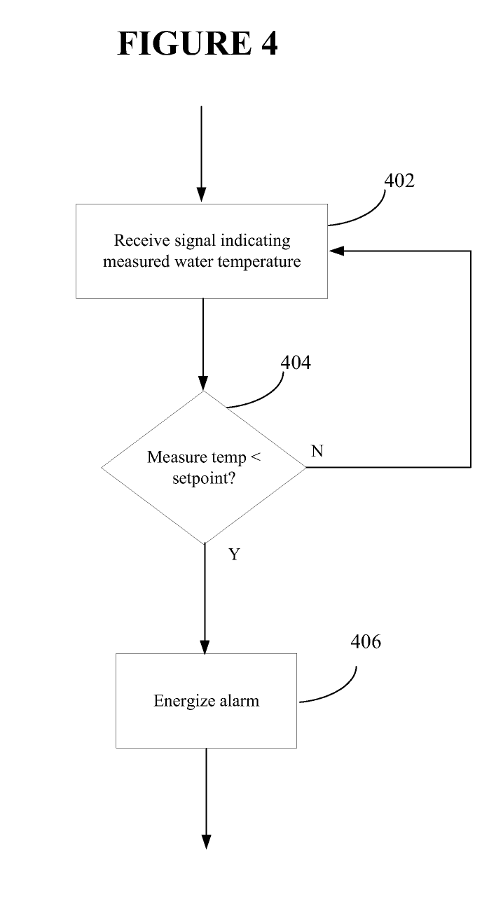

Those skilled in the art will appreciate that the operation of the controller 116 may be accomplished by a data processing device, such as a microprocessor (not shown), operating under software control. Referring now to FIG. 4, a flowchart describing one embodiment of a method that may be implemented in the software operating on the microprocessor is shown.

Unless specifically stated otherwise, or as is apparent from the discussion, terms such as “processing” or “computing” or “calculating” or “determining” or “displaying” or the like, refer to the action and processes of a data processing system, or similar electronic computing device, that manipulates and transforms data represented as physical, electronic quantities within the computer system's registers and memories into other data similarly represented as physical quantities within the computer system's memories or registers or other such information storage, transmission or display devices.

The process begins at block 402, where the microprocessor receives a signal from the temperature sensor 114. The signal includes a parameter, such as current, voltage, frequency, or the like, that is related to the temperature of the water within the water line 110. At decision block 404, the microprocessor compares the measured temperature to a minimum desired temperature, such as a temperature needed to achieve sanitary cleansing. If the measured temperature is greater that the setpoint, then the temperature of the water condition is at a desired level and control returns to the block 402 for repeated checking. On the other hand, if the measured temperature is less than the sanitary setpoint, then a fault has occurred and control transfers to block 406 where the alarm is energized to alert restaurant personnel of the fault.

Those skilled in the art will appreciate that the microprocessor may be configured to provide audible spoken alarms, indicating that the water temperature is too low. Moreover, the spoken alarm may also provide a contact telephone number for the manufacturer or maintenance group. In this way, the proper personnel may be quickly and easily notified of the fault so that it may be promptly corrected.

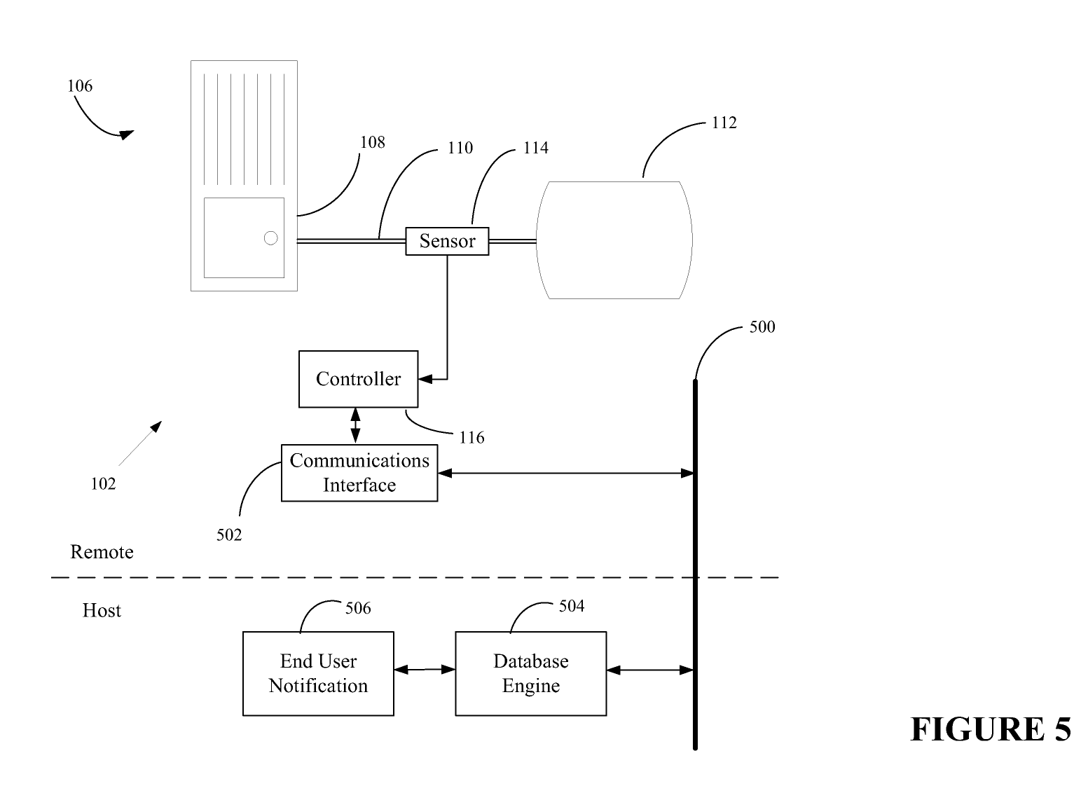

Turning now to FIG. 5, an alternative embodiment of the instant invention is illustrated in which an alarm may be indicated at a location remote from supply of hot water, such as at a host location, which may include a service provider. Thus, the embodiment of the instant invention operates in a manner similar to that described in conjunction with FIGS. 1-4, but rather than providing a local alarm, uses a communication channel 500 to provide an indication of a potential problem with the hot water supply to a service provider so that the problem may be promptly corrected. In one embodiment of the instant invention, the communication channel 500 may take the form of a telephone line, a cellular telephone link, a cable, an internet connection, a wireless connection, such as an 802.11a/b/g connection, a Bluetooth connection, or the like. In one embodiment of the instant invention, a communication interface 502 controllably communicates an alarm condition from the controller 116 over the communication channel 500 to the host location. In one embodiment of the instant invention, the alarm condition transmitted by the controller 116 includes information uniquely identifying the location at which the alarm condition occurred.

At the host location, a database engine 504 receives the alarm condition transmitted by the controller 116 and performs a look-up operation correlating the information identifying the location of the alarm condition with information related to the location, such as the action to be taken in response to receiving an alarm condition. For example, in one embodiment of the instant invention, the database engine 504 receives information that can be used to provide end user notification 506. For example, depending on the type of alarm condition received and the time of day, the end user notification 506 may contact an identified part or dispatch identified repair personnel to correct the condition that caused the alarm.

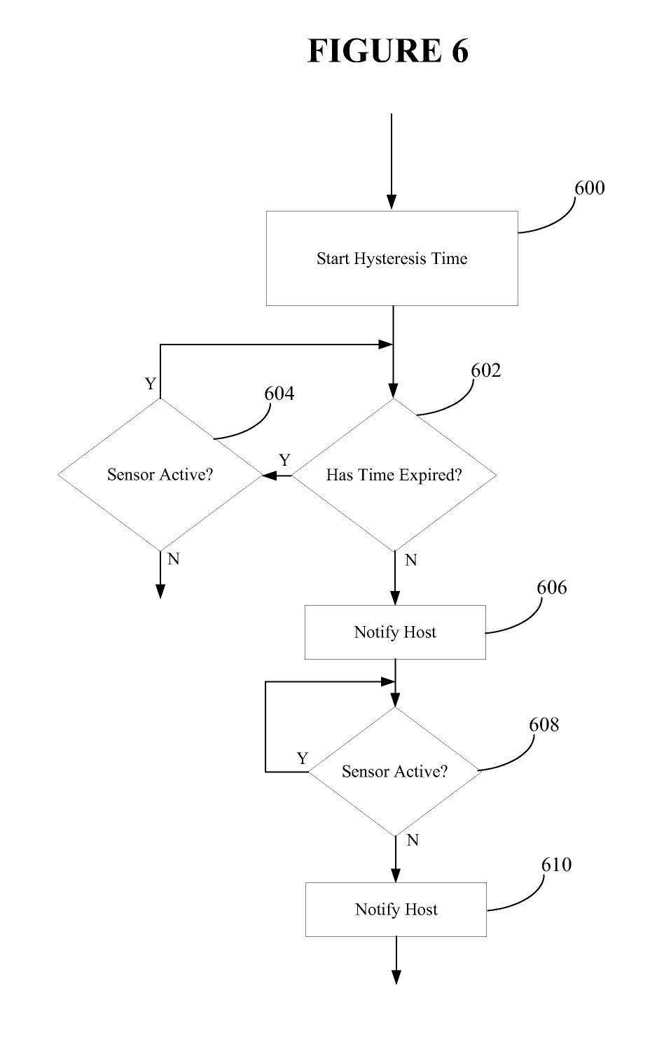

Turning now to FIG. 6, a flowchart describing an alternative embodiment of a method that may be implemented in the software operating on the microprocessor of the controller 116 is shown. The process begins at block 600 with the setting of a hysteresis time. The purpose of the hysteresis time is to prevent an alarm condition from being signaled for a temporary or transient condition. That is, the hysteresis time prevents service personnel from being called when the water temperature falls below the desired temperature for a relatively short period of time, but then promptly returns to the desired temperature. Control will continue to loop through decision blocks 602, 604 until either the timer expires or the sensor becomes inactive. For example, as long as the sensor remains active, indicating that the temperature of the water has fallen below a desired level, control will continue looping through decision blocks 602, 604. If the temperature sensor becomes inactive, indicating that the temperature of the water has returned to the desired level, then decision block 604 will cause control to pass out of the loop, ending the process. If, on the other hand, the time expires with the sensor still active, then decision block 602 passes control to block 606 where the host is notified of the alarm condition via the communication channel 500.

Thereafter, at decision block 608 the activity of the sensor is continuously monitored. As long as the sensor remains active, control loops back through decision block 608. Later, when the sensor becomes inactive, due to the temperature of the water returning to normal, control passes to block 610 where the host is notified of the sensor indicating that the water temperature has returned to the desired level.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for monitoring water temperature, comprising:
sensing water temperature; and
activating an alarm in response to the water temperature falling below a preselected setpoint.

2. A method, as set forth in claim 1, wherein sensing water temperature further comprises sensing a temperature of water supplied by a water heater.

3. A method, as set forth in claim 2, wherein sensing the temperature of water supplied by a water heater further comprises coupling a temperature sensor to a water line coupled to the water heater.

4. A method, as set forth in claim 1, wherein activating the alarm in response to the water temperature falling below the preselected setpoint further comprises activating a visual alarm in response to the water temperature falling below the preselected setpoint.

5. A method, as set forth in claim 4, wherein activating the visual alarm in response to the water temperature falling below the preselected setpoint further comprises providing an indication of a telephone number to be called when the alarm is activated.

6. A method, as set forth in claim 1, wherein activating the alarm in response to the water temperature falling below the preselected setpoint further comprises activating an audible alarm in response to the water temperature falling below the preselected setpoint.

7. A method, as set forth in claim 1, wherein activating the alarm in response to the water temperature falling below the preselected setpoint further comprises activating the alarm in response to the water temperature falling below a temperature useful for sanitary procedures.

8. A method, as set forth in claim 7, wherein activating the alarm in response to the water temperature falling below the temperature useful for sanitary procedures further comprises activating an alarm at a location adjacent an area in which the sanitary procedures are to be performed.

9. A method, as set forth in claim 7, wherein activating the alarm in response to the water temperature falling below the temperature useful for sanitary procedures further comprises activating an alarm at a location remote from an area in which the sanitary procedures are to be performed.

10. A method, as set forth in claim 9, wherein activating the alarm at the location remote from the area in which the sanitary procedures are to be performed further comprises activating the alarm at a location adjacent an office of a manager of a facility at which the sanitary procedures are to be performed.

11. An apparatus for monitoring water temperature, comprising:
a water heater;
a temperature sensor adapted to provide a signal having a parameter related to a temperature of water supplied by the water heater;
a controller adapted to compare the signal to a preselected setpoint and provide an alarm signal in response to the signal falling below the preselected setpoint; and
an alarm adapted to be energized in response to receiving the alarm signal.

12. An apparatus, as set forth in claim 11, wherein the temperature sensor is coupled to a water line coupled to the water heater.

13. An apparatus, as set forth in claim 11, wherein the alarm is a visual alarm.

14. An apparatus, as set forth in claim 13, wherein the visual alarm is adapted to provide an indication of a telephone number to be called when the alarm is activated.

15. An apparatus, as set forth in claim 11, wherein activating the alarm in response to the water temperature falling below the preselected setpoint further comprises activating an audible alarm in response to the water temperature falling below the preselected setpoint.

16. An apparatus, as set forth in claim 11, wherein the controller is adapted to compare the signal to a preselected setpoint related to a water temperature useful for sanitary procedures.

17. An apparatus, as set forth in claim 16, wherein the alarm is located adjacent an area in which the sanitary procedures are to be performed.

18. An apparatus, as set forth in claim 16, wherein the alarm is located remote from an area in which the sanitary procedures are to be performed.

19. An apparatus, as set forth in claim 18, wherein the alarm is located adjacent an office of a manager of a facility at which the sanitary procedures are to be performed.

20. An apparatus for monitoring water temperature, comprising:
a water heater;
means for providing a signal having a parameter related to a temperature of water supplied by the water heater;
means for comparing the signal to a preselected setpoint and provide an alarm signal in response to the signal falling below the preselected setpoint; and
an alarm adapted to be energized in response to receiving the alarm signal.
